(19) United States
(12) Patent Application Publication
(10) Pub. No.: US 2012/0130001 A1
(43) Pub. Date: May 24, 2012

(54) MODIFIED CELLULOSE FIBERS, PRODUCTION AND USE THEREOF

(76) Inventors: Thomas Pfeiffer, Bohl-Iggelheim (DE); Heike Pfistner, Ludwigshafen (DE); Szilard Csihony, Weinheim (DE); Ivette Garcia Castro, Ludwigshafen (DE); Michael Neuss, Carlsberg (DE); Thomas Zelinski, Neuleiningen (DE)

(21) Appl. No.: 13/388,580

(22) PCT Filed: Aug. 3, 2010
(86) PCT No.: PCT/EP10/61241

§ 371 Date: Feb. 2, 2012

(30) Foreign Application Priority Data
Aug. 10, 2009 (EP) 09167549.6
Aug. 25, 2009 (EP) 09168588.3

(51) Int. Cl. C08L 99/00; C08K 7/14

(52) U.S. Cl. 524/502; 525/54.21

(57) ABSTRACT

A method for producing composite materials which comprises in one step preparing modified cellulose fibers by treating
(A) cellulose fibers with an aqueous emulsion of
(B) at least one ethylene copolymer having a molecular weight Mₙ of up to 20 000 g/mol maximum and
   comprising as comonomers in incorporated form
   (a) 50% to 95% by weight of ethylene,
   (b) 5% to 50% by weight of at least one comonomer having at least one alkylated or cycloalkylated amino group which is connected via a spacer to a polymerizable group,
   (c) 0% to 30% by weight of other comonomers,
      and in a further step by mixing modified cellulose fibers with
(C) at least one thermoplastic
(D) and optionally one or more adjuvants.

The present invention relates to a method for producing composite materials which comprises in one step preparing modified cellulose fibers by treating
(A) cellulose fibers with an aqueous emulsion of
(B) at least one ethylene copolymer having a molecular weight Mₙ of up to 20 000 g/mol maximum and
   comprising as comonomers in incorporated form
   (a) 50% to 95% by weight of ethylene,
   (b) 5% to 50% by weight of at least one comonomer having at least one alkylated or cycloalkylated amino group which is connected via a spacer to a polymerizable group,
   (c) 0% to 30% by weight of other comonomers,
      and in a further step by mixing modified cellulose fibers with
(C) at least one thermoplastic
(D) and optionally one or more adjuvants.

The present patent application further relates to cellulose fibers treated with at least one aqueous emulsion of
(B) at least one ethylene copolymer having a molecular weight Mₙ of up to 20 000 g/mol maximum and comprising as comonomers in incorporated form
   (a) 50% to 95% by weight of ethylene,
   (b) 5% to 50% by weight of at least one comonomer having at least one alkylated or cycloalkylated amino group which is connected via a spacer to a polymerizable group,
   (c) 0% to 30% by weight of other comonomers.

The present invention further relates to the use of cellulose fibers of the invention for producing composite materials.

Wood as a material has been known to humankind for several millennia already. It is distinguished by ready availability in most parts of the world. In addition, through numerous processing technologies, the ways in which wood can be used are diverse. In many countries, wood continues to be used even today for applications in the exterior of buildings, as for example in the production of roofs, façades, window frames, and verandahs, and also in the production of benches such as park benches, for example, and for the production of hollow articles such as, for example, hollow-chamber profiles for decking or windowsills.

One serious disadvantage affecting the use of wood in the exterior of buildings, however, is its deficient weathering stability. Hot and humid weathering in particular may result in rotting. Attempts to protect wood by coating, such as by varnish coats, for example, against the effects of weathering may indeed retard rotting, but are unable to prevent it entirely. Varnish coats have the drawback, moreover, that they must be renewed at regular intervals. Furthermore, many varnish systems are sensitive to mechanical loads and damage, and this may lead, for example, to the flaking of the coating system. Moreover, wood can be shaped only by means of costly and inconvenient techniques, which give rise to large quantities of waste.

There has been no lack of attempts to replace wood with plastics. Plastics such as polyvinyl chloride or polyolefins such as polyethylene or polypropylene, for example, have thermal expansion coefficients which in many outdoor applications prove to be excessive. In addition, in many cases the stiffness is too low.

As a solution to numerous problems, in very recent times, composite materials of wood and plastic have been made available (also known as wood-plastic composites, WPC for short). These materials are produced by mixing plastics material and wood fibers. Composite materials of this kind exhibit significantly higher weathering stability than pure wood, and better mechanical properties than certain pure plastics, such as polyethylene or polypropylene. Furthermore, with the aforementioned composite materials, it is possible to carry out shaping techniques such as those with pure thermoplastics, examples being injection molding and extrusion.

One problem of wood-plastic composite materials, however, is in many cases the inadequate attachment of the wood and plastics constituents to one another. If attachment is inadequate, then in many cases the mechanical strength leaves something to be desired.

WO 2008/101937 discloses composite materials comprising natural fibers, wood for example, and thermoplastic polymers, and also, optionally, other substances. The composite materials are produced by mixing natural fibers, thermoplastic, and certain ethylene copolymer waxes, and also, optionally, other substances. In some cases, however, processing takes a relatively long time, and this is unfavorable from a process engineering standpoint. Furthermore, some of the mechanical properties such as tensile strength, flexural strength, impact toughness, breaking stress, elongation at break and/or stretch elongation are capable of improvement.

WO 2007/118264 discloses a method for treating cellulosic fiber materials with solutions containing magnesium ions. The resulting treated materials are suitable for packaging applications, but because of degradation reactions that occur they are not suitable for composite materials. In many cases, additionally, the water repellency properties are capable of improvement.

One object, therefore, was to provide a method for producing composite materials that improves the homogeneity and hence the properties of composite materials. A further object was to provide composite materials which exhibit particularly good mechanical properties such as tensile strength, flexural strength, impact toughness, breaking stress, elongation at break and/or stretch elongation, and also lower water absorption. Yet another object was to provide uses for composite materials.

Accordingly, the method defined at the outset has been found, and is also referred to below as the method of the invention.

The method of the invention starts from cellulose fibers (A). Cellulose fibers in the context of the present invention also include lignocellulosic fibers. Examples of cellulose fibers (A) are fibers of flax, sisal, hemp, coir, of abaca (known as Manila hemp), but also rice husks, bamboo, straw, and peanut shells. Preferred examples of cellulose fibers (A) are wood fibers. These wood fibers may be fibers of freshly harvested wood or of used wood. Furthermore, wood fibers may be fibers of different wood species such as soft woods, of fir, spruce, pine or larch, for example, and hard woods of beech and oak, for example. Wood wastes as well, such as planings, sawings or sawdust, for example, are suitable. The wood composition may vary in terms of its constituents such as cellulose, hemicellulose, and lignin.

In one embodiment of the present invention, cellulose fibers (A) comprise pulp. Pulp may be unbleached or bleached pulp. Pulp for the purposes of the present invention may be obtained by alkaline or acidic digestion methods.

Pulp in the sense of the present invention may have a lignin content in the range from zero to 20% by weight.

In one embodiment of the present invention, cellulose fibers (A) have a kappa number in the range from zero to 100.

In one embodiment of the present invention, cellulose fibers (A) have an average length in the range from 0.1 to 100 mm, preferably from 1 to 10 mm.

In one preferred embodiment of the present invention, cellulose fibers (A) are long-fiber pulp. Long-fiber pulp for the purposes of the present invention may have a length in the range from 1 to 7 mm.

Long-fiber pulp in the sense of the present invention may have a particle width in the range from 10 to 50 μm.

Long-fiber pulp for the purposes of the present invention may have a coarseness (fiber weight) in the range from 100 to 500 mg/m.

In one embodiment of the present invention the length/thickness ratio of cellulose fibers (A) is in the range from 500:1 to 50:1, more particularly when cellulose fibers (A) are selected from long-fiber pulp.

In another embodiment of the present invention, cellulose fibers (A) are selected from short-fiber pulps, which may have, for example, a length of 0.2 to 1.5 mm and a length/diameter ratio in the range from 200:1 to 40:1.

The method of the invention comprises at least two steps, more particularly at least two separate steps. In one step, also referred to as the first step in the context of the present invention, cellulose fibers are treated with at least one aqueous emulsion of (B) at least one ethylene copolymer, also referred to for short in the context of the present patent application as ethylene copolymer (B), having a molecular weight Mₙ of up to 20 000 g/mol maximum, preferably 1 000 to 15 000 g/mol, and comprising as comonomers in copolymerized form
(a) 50% to 95%, preferably 55% to 90%, more preferably 60% to 80% by weight of ethylene,
(b) 5% to 50%, preferably 10% to 45%, more preferably 20% to 40% by weight of at least one comonomer having at least one alkylated or cycloalkylated amino group which is connected via a spacer to a polymerizable group,
(c) zero to a total of 30% by weight, preferably to a total of 20% by weight, and particularly of one or more other comonomers.

Here, figures in % by weight are based on total ethylene copolymer (B).

Suitable spacers with which alkylated or cycloalkylated amino groups may be bonded to a polymerizable group include cyclic or linear organic groups which comprise 1 to 20 C atoms and optionally at least one heteroatom. Heteroatoms include sulfur and, in particular, nitrogen and oxygen.

In one embodiment of the present invention, ethylene copolymer (B) has a kinematic melt viscosity v in the range from 60 to 150 000 mm²/s, preferably from 300 to 90 000 mm²/s, measured at 120° C. in accordance with DIN 51562.

In one embodiment of the present invention the melting point of ethylene copolymer (B) is in the range from 40 to 110° C., preferably in the range up to 100° C., determined by DSC in accordance with DIN 51007.

In one embodiment of the present invention the density of ethylene copolymer (B) is in the range from 0.85 to 0.99 g/cm³, preferably up to 0.97 g/cm³, determined in accordance with DIN 53479.

In one embodiment of the present invention comonomer (b) is a compound of the general formula I or I a

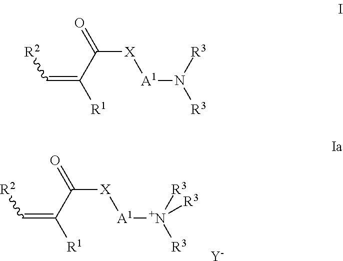

in which the variables are defined as follows:

R¹ and R² are identical or different;

R¹ is selected from hydrogen and

unbranched and branched C₁-C₁₀-alkyl, such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; more preferably C₁-C₄-alkyl such as methyl, ethyl, n-propyl, isopropyl, n-butyl, isobutyl, sec-butyl, and tert-butyl, more particularly methyl;

R² is selected from unbranched and branched C₁-C₁₀-alkyl such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; more preferably C₁-C₄-alkyl such as methyl, ethyl, n-propyl, isopropyl, n-butyl, isobutyl, sec-butyl, and tert-butyl, more particularly methyl;

and very preferably hydrogen.

R³ radicals are different or preferably the same and are selected from hydrogen and branched and preferably unbranched C₁-C₁₀-alkyl, as for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; preferably methyl, ethyl, n-propyl, n-butyl, n-pentyl, isopentyl, n-hexyl, n-heptyl, n-octyl, n-nonyl, n-decyl; more preferably C₁-C₄-alkyl such as methyl, ethyl, n-propyl, isopropyl, n-butyl, isobutyl, sec-butyl, and tert-butyl, very preferably methyl;

C₃-C₁₂-cycloalkyl such as, for example, cyclopropyl, cyclobutyl, cyclopentyl, cyclohexyl, cycloheptyl, cyclooctyl, cyclononyl, cyclodecyl, cycloundecyl, and cyclododecyl; preferably cyclopentyl, cyclohexyl, and cycloheptyl.

It is possible here for two radicals R³ to be connected to one another to form an optionally C₁-C₄-alkyl-substituted 3- to 10-membered, preferably 5- to 7-membered, ring;

more preferably a group N(R³)2 may be selected from

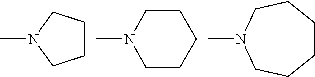

If the radicals R³ are different, then one of the radicals R³ may preferably be hydrogen.

X is selected from sulfur, N—R⁴, and more particularly oxygen.

R⁴ is selected from hydrogen and also unbranched and branched C₁-C₁₀-alkyl such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; more preferably C₁-C₄-alkyl such as methyl, ethyl, n-propyl, isopropyl, n-butyl, isobutyl, sec-butyl, and tert-butyl, more particularly methyl or hydrogen, preferably hydrogen;

A¹ is selected from divalent groups such as

C₁-C₁₀-alkylene, such as, for example, —CH₂—, —CH(CH₃)—, —(CH₂)₂—, —CH₂—CH(CH₃)—, cis- and trans-CH(CH₃)—CH(CH₃)—, —(CH₂)₃—, —CH₂—CH(C₂H₅)—, —(CH₂)₄—, —(CH₂)₅—, —(CH₂)₆—, —(CH₂)₇—, —(CH₂)₈—, —(CH₂)₉—, —(CH₂)₁₀—; preferably C₂-C₄-alkylene, such as —(CH₂)₂—, —CH₂—CH(CH₃)—, —(CH₂)₃—, —(CH₂)₄—, and —CH₂—CH(C₂H₅)—, more preferably —(CH₂)₂—, —(CH₂)₃—, —(CH₂)₄—, and very preferably —(CH₂)₂—.

C₄-C₁₀-cycyloalkylene such as, for example

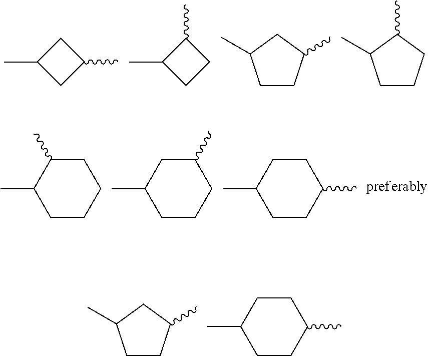

in isomerically pure form or as an isomer mixture, and

phenylene, as for example ortho-phenylene, meta-phenylene, and, with particular preference, para-phenylene.

Y⁻ is an anion of an inorganic or organic acid, as for example sulfate or phosphate, preferably a singly negatively charged anion, as for example halide, more particularly chloride or bromide, and also hydrogensulfate, C₁-C₄-alkylsulfate, more particularly methylsulfate, dihydrogenphosphate, formate, acetate, propionate, stearate, palmitate, citrate, tartrate. Where Y⁻ is selected from anions of polybasic acids, such as sulfate or phosphate, for example, an anion Y⁻ may serve for electrical neutralization of more than one equivalent of comonomer (b).

In one embodiment of the present invention R¹ is hydrogen or methyl. Very preferably R¹ is methyl.

In one embodiment of the present invention R¹ is hydrogen or methyl and R² is hydrogen.

In one embodiment of the present invention R¹ is hydrogen or methyl and R² is hydrogen, and both groups R³ are identical and are each methyl or ethyl.

In one embodiment of the present invention X-A¹-N(R³)₂ is O—CH₂—CH₂—N(CH₃)₂.

In one embodiment of the present invention X-A¹-N(R³)₂ is O—CH₂—CH₂—CH₂—N(CH₃)₂.

In one embodiment of the present invention X-A¹-N(R³)₃ Y⁻ is O—CH₂—CH₂—N(CH₃)₃ Y—, where Y— is selected from acetate, stearate, palmitate, and methylsulfate (CH₃SO₄—).

In one embodiment of the present invention X-A¹-N(R³)₃ Y⁻ is O—CH₂—CH₂—CH₂—N(CH₃)₃, where Y— is selected from acetate, stearate, palmitate, and methylsulfate (CH₃SO₄—).

In one embodiment of the present invention ethylene copolymer (B) comprises no further comonomers (c) in copolymerized form.

In another embodiment of the present invention ethylene copolymer (B) comprises at least one further comonomer in copolymerized form, selected from C₁-C₂₀-alkyl esters of ethylenically unsaturated C₃-C₁₀-monocarboxylic acids, also called ethylenically unsaturated C₃-C₁₀-carboxylic esters for short, examples being methyl (meth)acrylate, ethyl (meth)acrylate, n-butyl (meth)acrylate, n-hexyl (meth)acrylate, 2-ethylhexyl (meth)acrylate, n-octyl (meth)acrylate, n-decyl (meth)acrylate, 2-propylheptyl (meth)acrylate.

Mono- and di-C₁-C₁₀-alkyl esters of ethylenically unsaturated C₄-C₁₀-dicarboxylic acids, examples being monomethyl and dimethyl maleate, monoethyl and diethyl maleate, monomethyl and dimethyl fumarate, monoethyl and diethyl fumarate, monomethyl and dimethyl itaconate, mono-n-butyl and di-n-butyl maleate, and mono-2-ethylhexyl and di-2-ethylhexyl maleate, vinyl esters or allyl esters of C₁-C₁₀-carboxylic acids, preferably vinyl esters or allyl esters of acetic acid or propionic acid, with vinyl propionate being particularly preferred and vinyl acetate especially preferred.

In one embodiment of the present invention comonomer (b) is in protonated form.

Ethylene copolymer (B) may be prepared by conventional processes for the copolymerization of ethylene (a), comonomer (b), and optionally other comonomers (c), in stirred high-pressure autoclaves or in high-pressure tube reactors. Preparation in stirred high-pressure autoclaves is preferred. Stirred high-pressure autoclaves are known; a description is found, for example, in Ullmann's Encyclopedia of Industrial Chemistry, 5th Edition, Entry headings: Waxes, Vol. A 28, p. 146 ff., Verlag Chemie Weinheim, Basel, Cambridge, N.Y., Tokyo, 1996. With such autoclaves the length/diameter ratio is predominantly in ranges from 5:1 to 30:1, preferably 10:1 to 20:1. The high-pressure tube reactors which can likewise be employed are likewise found in Ullmann's Encyclopedia of Industrial Chemistry, 5th Edition, Entry headings: Waxes, Vol. A 28, p. 146 ff., Verlag Chemie Weinheim, Basel, Cambridge, N.Y., Tokyo, 1996. Details relating to the preparation of ethylene copolymer are also given in WO 2008/101937.

The preparation of aqueous emulsions of ethylene copolymer (B) is known per se. A preferred procedure is to place one or more ethylene copolymers (B) in a vessel, such as a flask, an autoclave or a tank, for example, and to heat the ethylene copolymer or copolymers (B) and one or more Brønsted acids, and optionally further substances, water for example, the sequence of addition of Brønsted acid or Brønsted acids and also, optionally, other substances being arbitrary. If it is desired to prepare the emulsion in question at a temperature above 100° C., it is advantageous to operate under elevated pressure and to select the vessel accordingly. The emulsion formed is homogenized, by means, for example, of mechanical or pneumatic stirring or by shaking. It is heated advantageously to a temperature above the melting point of ethylene copolymer (B). It is heated advantageously to a temperature which is at least 10° C., with particular advantage to a temperature which is at least 30° C., above the melting point of ethylene copolymer (B).

The amount of Brønsted acid used can be such that ethylene copolymer (B) is present in partially or, preferably, completely neutralized form. In one embodiment of the present invention an excess of Brønsted acid is used.

If ethylene copolymer (B) is a compound of the general formula I a, then there is no need to add Brønsted acid.

In one embodiment of the present invention the aqueous emulsion used in the first step has a solids content in the range from 1% to 40% by weight, preferably 10% to 30% by weight, more preferably 15% to 25% by weight.

The treatment of cellulose fibers (A) with aqueous emulsion of ethylene copolymer (B) may be carried out at temperatures in the range from 10 to 70° C., preference being given to 20 to 60° C.

In one embodiment of the present invention it is possible during the treatment with aqueous emulsion of ethylene copolymer (B) to add one or more auxiliaries, examples being water repellency agents or sizing agents.

In another embodiment of the present invention no auxiliaries are added during the treatment with aqueous emulsion of ethylene copolymer (B).

In one embodiment of the present invention the treatment of cellulose fibers (A) with aqueous emulsion of ethylene copolymer (B) may be carried out with accompanying homogenization, as for example by means of or with the aid of static mixers or by means of pumps.

In one embodiment of the present invention homogenization takes place with a relatively low energy input, as for example 0.2 to 5.0 kWh/t.

In one embodiment of the present invention the pH in the first step of the method of the invention is in the range from 4 to 10, preferably 6 to 9.

In one embodiment of the present invention the first step of the method of the invention is carried out under atmospheric pressure.

In one embodiment of the present invention the first step of the method of the invention can be carried out in a stirred vessel.

Following the treatment of cellulose fibers (A) with aqueous emulsion of ethylene copolymer (B), the cellulose fibers treated in accordance with the invention are dried. For this purpose, water, at least to a certain fraction, and optionally wastes, are separated off. This gives modified cellulose fibers.

After the first step of the method of the invention, the cellulose fibers treated in accordance with the invention can be treated to remove water and any wastes by mechanical methods, as for example by pressing or filtering.

In one embodiment of the present invention it is possible to remove water by thermal drying, at temperatures, for example, in the range from 100 to 300° C.

In one embodiment of the present invention cellulose fibers treated in accordance with the invention are dried thermally to a residual moisture content in the range from zero to 20% by weight, preferably at least 0.1% by weight, more preferably 5% to 10% by weight. The residual moisture content is determined by IR spectroscopy, for example.

In one embodiment of the present invention the drying is carried out by a combination of at least two operations, as for example by a combination of a mechanical method, followed by thermal drying.

Water can be removed using filters or presses, for example.

In one embodiment of the present invention it is possible to recycle removed water still containing residues of ethylene copolymer (B) and to use it, for example, for treating a further portion of cellulose fibers (A).

In another step of the method of the invention modified cellulose fibers, i.e., cellulose fibers obtained by inventive treatment of cellulose fibers (A) with aqueous emulsion of ethylene copolymer (B), are mixed

with (C) at least one thermoplastic

and optionally with (D) one or more adjuvants.

Thermoplastic (C) here encompasses any thermoplastically deformable polymers, which may be virgin or recyclate from old thermoplastic polymers. Thermoplastic (C) is selected preferably from polyolefins, more preferably polyethylene, especially HDPE, polypropylene, especially isotactic polypropylene, and polyvinyl chloride (PVC), as for example plasticized PVC and especially unplasticized PVC, and also polyvinyl acetate, or from mixtures of polyethylene and polypropylene.

It is preferred to select thermoplastic (C) from polyethylene, polypropylene, polyvinyl chloride, polystyrene, and polyester.

Polyethylene and polypropylene here in each case also include copolymers of the ethylene or propylene, respectively, with one or more α-olefins or styrene as well. Accordingly, in the context of the present invention, polyethylene also encompasses copolymers which as well as ethylene as their principal monomer (at least 50% by weight) comprise one or more comonomers in copolymerized form, selected from styrene or α-olefins such as, for example, propylene, 1-butene, 1-hexene, 4-methyl-1-pentene, 1-octene, 1-decene, 1-dodecene, n-α-C₂₂H₄₄, n-α-C₂₄H₄₈, and n-α-C₂₀H₄₀. In the context of the present invention, polypropylene also encompasses copolymers which as well as propylene as their principal monomer (at least 50% by weight) comprise one or more comonomers in copolymerized form, selected from styrene, ethylene, 1-butene, 1-hexene, 4-methyl-1-pentene, 1-octene, 1-decene, 1-dodecene, n-α-C₂₂H₄₄, n-α-C₂₄H₄₈, and n-α-C₂₀H₄₀.

In one embodiment of the present invention thermoplastic (C) has an average molecular weight M_{w} in the range from 50 000 to 1 000 000 g/mol.

In one embodiment of the present invention, furthermore, mixing is carried out with at least one adjuvant (D). Examples of adjuvants (D) are coupling agents (compatibilizers), examples being maleinized polyethylenes or polypropylenes, or copolymers of ethylene or propylene and acrylic acid or methacrylic acid. Further examples of suitable adjuvants (D) are stabilizers, more particularly light stabilizers and UV stabilizers, examples being sterically hindered amines (HALS), 2,2,6,6-tetramethylmorpholine N-oxides or 2,2,6,6-tetramethylpiperidine N-oxides (TEMPO) and other N-oxide derivatives such as NOR. Further examples of suitable adjuvants (D) are UV absorbers such as, for example, benzophenone or benzotriazoles. Other examples of suitable adjuvants (D) are pigments, which may likewise provide stabilization against UV light, such as titanium dioxide, carbon black, iron oxide, other metal oxides, and organic pigments, examples being azo pigments and phthalocyanine pigments, for example. Other examples of suitable adjuvants (D) are biocides, more particularly fungicides. Other examples of suitable adjuvants (D) are acid scavengers, examples being alkaline earth metal hydroxides or alkaline earth metal oxides or fatty acid salts of metals, more particularly metal stearates, very preferably zinc stearate and calcium stearate, and also chalk and hydrotalcites. Certain fatty acid salts of metals, more particularly zinc stearate and calcium stearate, may also act here as lubricants in the course of processing.

Further examples of adjuvants (D) are antioxidants such as those based on phenols, such as alkylated phenols, bisphenols, bicyclic phenols, or antioxidants based on benzofuranones, organic sulfides and/or diphenylamines. Other examples of suitable adjuvants (D) are plasticizer esters of dicarboxylic acids such as phthalates, organic phosphates, polyesters, and polyglycol derivatives. Further examples of suitable adjuvants (D) are impact modifiers and flame retardants.

In one embodiment of the present invention the mixing is carried out in an extruder, as for example in a corotating or counter rotating twin-screw extruder.

In one embodiment of the present invention modified cellulose fibers, thermoplastic (C), and optionally one or more additives (D) are supplied, in a direct extrusion process, to the extruder, melted, mixed, and processed to a ready semifinished product made from composite material.

Examples of semifinished products are building interior parts, building exterior parts such as façade parts, for example, and also profile parts, interior trim and underbody trim in the automotive sector, furniture, and hollow articles.

In another embodiment of the present invention modified fibers (A), thermoplastic (C), and optionally one or more additives (D) are processed by mixing first of all to give a composite material which is obtained, for example, in pellet form, and which is thereafter processed, for example, to form one or more semifinished products.

The temperature at which mixing is carried out is preferably selected such that it is at least 10° C., preferably at least 20° C., above the melting point of thermoplastic (C).

In one embodiment of the present invention

60% to 90% by weight of modified cellulose fibers and

10% to 40% by weight of thermoplastic (C), based on the respective weight, are mixed.

The present invention further provides cellulose fibers treated with at least one emulsion of
(B) an ethylene copolymer having a molecular weight Mₙ of up to 20 000 g/mol maximum and comprising as comonomers in incorporated form
   (a) 50% to 95% by weight of ethylene,
   (b) 5% to 50% by weight of at least one comonomer having at least one alkylated or cycloalkylated amino group which is connected via a spacer to a polymerizable group,
   (c) 0% to 30% by weight of other comonomers.

Comonomer (b) and optionally further comonomer (c) have been described above. The cellulose fibers of the invention, also referred to in the context of the present invention as “modified cellulose fibers” or “modified cellulose fibers of the invention”, are especially suitable for use in the method described above.

Modified cellulose fibers of the invention can be separated very effectively, and the tensile strength of a sheet formed from such fibers is lower by 30% to 80% than that of a sheet of untreated fibers. This separability affects neither the individual fiber strength nor the fiber-matrix bonding.

In one embodiment of the present invention modified cellulose fibers of the invention are free from thermoplastic (C), i.e., the fraction of thermoplastic is in the range from zero to 0.5% by weight, based on the dry weight of modified cellulose fibers of the invention.

In one embodiment of the present invention the weight ratio of the cellulose fibers (A) to ethylene copolymer (B) in modified cellulose fibers of the invention is in the range from 1000:1 to 20:1, preferably 500:1 to 50:1.

In one preferred embodiment of the present invention cellulose fibers (A) which serve as one of the starting materials for producing modified cellulose fibers of the invention are selected from long-fiber pulp. This long-fiber pulp is as defined above.

In one embodiment of the present invention modified cellulose fibers of the invention have a residual moisture content in the range from zero to 20% by weight, preferably 5% to 10% by weight. The residual moisture content is determined for example by IR spectroscopy or by storage in a drying cabinet for a number of hours.

The present invention additionally provides for the use of modified cellulose fibers of the invention for producing composite materials, preferably those which comprise at least one thermoplastic (C). The present invention further provides a method for producing composite materials using modified cellulose fibers of the invention.

The present invention additionally provides composite materials produced using modified cellulose fibers of the invention. Composite materials of the invention are outstandingly suitable as or for the production of building interior or exterior parts or profile parts. Examples of building interior part are balustrades, examples being those for interior staircases, and panels. Examples of building exterior parts are roofs, façades, roof constructions, window frames, verandahs, balustrades for exterior stairs, decking, and cladding, for buildings or parts of buildings, for example. Examples of profile parts are technical profiles, connecting hinges, moldings for interior applications such as moldings with complex geometries, for example, multifunctional profiles or packaging parts, and decorative parts, furniture profiles, and floor profiles. In addition, composite materials of the invention are suitable for packaging, as for example for boxes and crates.

Additionally provided for the present invention is the use of composite materials of the invention as or for production of furniture, examples being tables, chairs, more particularly garden furniture, and benches, such as park benches, for example, for the production of profile parts and for the production of hollow articles such as, for example, hollow-chamber profiles for decking or windowsills. The present invention additionally provides a method for producing building exterior parts, furniture, profile parts or hollow articles using at least one composite material of the invention.

The present invention additionally provides building interior parts and building exterior parts, profile parts, furniture, and hollow articles, produced using at least one composite material of the invention.

Building exterior parts and benches of the invention exhibit superior weathering resistance, and also have an outstanding feel and very good mechanical properties such as, for example, impact toughness, good flexural elasticity modulus, and low water absorption, resulting in good weathering dependency. Furthermore, the thermal properties are very good. In addition they have an attractive appearance similar to that of wood.

The invention is illustrated by examples.

### 1. Preparation of Ethylene Copolymer

A high-pressure autoclave, of the type described in the literature (M. Buback et al, Chem. Ing. Tech. 1994, 66, 510) was used for continuous copolymerization of ethylene and N,N-dimethylaminoethyl methacrylate (DMAEMA)

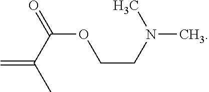

For this purpose, ethylene (12.0 kg/h) was fed continuously into the high-pressure autoclave under the reaction pressure of 1700 bar. Separately from this, the amount of N,N-dimethylaminoethyl methacrylate indicated in Table 1, optionally diluted with the isododecane quantity indicated in Table 1, column 5, was first compressed to an intermediate pressure of 260 bar and then fed continuously into the high-pressure autoclave, with the aid of a further compressor, under the reaction pressure of 1700 bar. Separately from this, the quantity of initiator solution indicated in Table 1 and consisting of tert-amyl peroxypivalate (in isododecane, for concentration see Table 1), was fed continuously into the high-pressure autoclave under the reaction pressure of 1700 bar. Separately from this, optionally, the amount of propionaldehyde indicated in Table 1 was first compressed to an intermediate pressure of 260 bar and then fed continuously into the high-pressure autoclave, with the aid of a further compressor, under the reaction pressure of 1700 bar. The reaction temperature was around 220° C. Ethylene copolymer was obtained which had the analytical data which are apparent from Table 2.

TABLE 1
Preparation of ethylene copolymers

| | | | | | | | | Con- | |
|---|---|---|---|---|---|---|---|---|---|
| | | Ethyl- | | | | PO | | ver- | EC |
| | T_{reactor} | ene | DMAEMA | | PA | in ID | | sion | output |
| No. | [° C.] | [kg/h] | [l/h] | ID | [ml/h] | [l/h] | c(PO) | [%] | [kg/h] |
| (B.1) | 220.6 | 12 | 1.67 | 235 | 235 | 1.64 | 0.05 | 23.0 | 3.2 |
| (B.2) | 220.2 | 12 | 1.67 | 105 | 105 | 2.21 | 0.05 | 22.7 | 3.1 |
| (B.3) | 219.8 | 12 | 1.67 | 255 | 15 | 1.70 | 0.06 | 23.0 | 3.2 |
| (B.4) | 219.8 | 12 | 1.22 | 135 | 135 | 1.14 | 0.06 | 21.2 | 2.8 |
| (B.5) | 218.6 | 12 | 1.22 | 988 | 52 | 1.35 | 0.06 | 20.0 | 2.7 |
| (B.6) | 220.8 | 12 | 1.22 | 256 | 13.5 | 1.71 | 0.06 | 21.2 | 2.8 |

T_{reactor} refers to the maximum internal temperature of the high-pressure autoclave.
Abbreviations: DMAEMA: N,N-dimethylaminoethyl methacrylate,
PA: propionaldehyde,
ID: isododecane (2,2,4,6,6-pentamethylheptane),
PA in ID: solution of propionaldehyde in isododecane, total volume of the solution.
PO: tert-amyl peroxypivalate,
c(PO): concentration of PO in ID in mol/l
EC: ethylene copolymer

The conversion is based on ethylene and is reported in % by weight

TABLE 2
Analytical data of ethylene copolymers used

| | | | Ethyl- | | | | |
|---|---|---|---|---|---|---|---|
| | Ethyl- | | ene | | | | |
| | ene | | con- | | | | |
| | content | DMAEMA | tent | DMAEMA | | | |
| | [% by | content [% | [mol | content | η | ρ | Tₘₑₗₜ |
| No. | weight] | by weight] | %] | [mol %] | [mPa · s] | [g/cm³] | [° C.] |
| (B.1) | 62.8 | 37.2 | 90.4 | 9.6 | 1000 | 0.870 | 48.2 |
| (B.2) | 62.8 | 37.2 | 90.4 | 9.6 | 2603 | 0.875 | 48.8 |
| (B.3) | 62.2 | 37.8 | 90.2 | 9.8 | 6357 | 0.882 | 43.2 |
| (B.4) | 67.8 | 32.2 | 92.1 | 7.9 | 3432 | 0.853 | 40.1 |
| (B.5) | 67.4 | 32.6 | 92.2 | 7.8 | 7067 | 0.853 | 41.4 |
| (B.6) | 69.6 | 30.4 | 92.6 | 7.4 | 10645 | 0.868 | 46.7 |

By “content” is meant the fraction of copolymerized ethylene and DMAEMA, respectively, in the particular ethylene copolymer.
η: dynamic melt viscosity, measured at 120° C. in a plate/cone viscometer (PP 35 Ti) 1.0 mm gaps, and D = 10 [1/s] in accordance with DIN 53018-1

The ethylene content and N,N-dimethylaminoethyl methacrylate content of the ethylene copolymers were determined by ¹H NMR spectroscopy.

The density was determined in accordance with DIN 53479. The melting point Tₘₑₗₜ or melting range was determined by DSC (Differential scanning calorimetry) in accordance with DIN 51007.

### 2. Preparation of Aqueous Emulsions of Ethylene Copolymers

### 2.1 Preparation of Acetic Emulsions

2.1.1 General Preparation Instructions

A 2-liter autoclave with anchor stirrer was charged with the amount indicated in Table 3 of ethylene copolymer (B) according to Example 1. This initial charge was heated to 130° C. with stirring, followed by dropwise addition over the course of 15 minutes of the amount of 37% by weight aqueous acetic acid indicated in Table 3, as per Table 1, feed 1. Thereafter, over the course of 30 minutes, the remaining amount of water was added, feed 2, and stirring was continued for 15 minutes at 130° C. (external temperature). Thereafter the external temperature was lowered to 100° C., and the mixture was stirred at 100° C. for an hour and then cooled to room temperature over the course of 15 minutes. It was filtered with a Perlon filter (100 μm) to give the aqueous emulsions in question. Details and also properties of the emulsions obtained are collated in Table 3.

2.1.2 Alternative Preparation Instructions for Product B.2

A 2-liter autoclave with anchor stirrer was charged with 199.9 g of water, with 42.4 g of acetic acid as initial charge. The mixture was heated with stirring at 110° C. (external temperature) for 30 minutes. Then 300 g of an ethylene/DMAEMA copolymer, melted at 115° C., prepared in accordance with Example 1, were added very rapidly by means of a heatable feed funnel. After the end of the feed, stirring was continued for 10 minutes at approximately 97° C. (internal temperature). Subsequently 250 g of water were metered in at 130° C. (external temperature) over 15 minutes, after which 707.7 g of water were added very rapidly. This was followed by further stirring at 97° C. (internal temperature) for 2 hours. The emulsion was cooled to 60° C. (internal temperature) and thereafter filtered off on a Perlon filter (100 mm).

TABLE 3
Emulsions of ethylene copolymers (B)

| | | Glacial acetic | Amount | | | Solids |
|---|---|---|---|---|---|---|
| | Amount | acid [g] | of H₂O | Molar ratio | pH of | content |
| | of (B) | in water | [g], | amino | emul- | [% by |
| No. | [g] | Feed 1 | Feed 2 | groups:acid | sion | weight] |
| (B.1) | 225 | 32 g glacial | 800 | 1:1 | 4.9 | 20 |
| | | acetic acid in | | | | |
| | | 69 ml H₂O | | | | |
| (B.2) | 225 | 32 g glacial | 800 | 1:1 | 4.9 | 20 |
| | | acetic acid in | | | | |
| | | 69 ml H₂O | | | | |
| (B.3) | 225 | 32 g glacial | 800 | 1:1 | 4.9 | 20 |
| | | acetic acid in | | | | |
| | | 69 ml H₂O | | | | |
| (B.4) | 225 | 28 g glacial | 800 | 1:1 | 4.6 | 20 |
| | | acetic acid in | | | | |
| | | 72 ml H₂O | | | | |
| (B.5) | 225 | 27.7 g glacial | 800 | 1:1 | 4.6 | 20 |
| | | acetic acid in | | | | |
| | | 72.2 ml H₂O | | | | |
| (B.6) | 225 | 26.6 g glacial | 800 | 1:1 | 4.6 | 20 |
| | | acetic acid in | | | | |
| | | 73.4 ml H₂O | | | | |

### 2.2 Preparation of Phosphoric Emulsions

A 2-liter autoclave with anchor stirrer was charged with 225 g of ethylene copolymer (B.2) according to Example 1, and also with phosphoric acid and water as per Table 4. This initial charge was heated with stirring to 130° C. and then the mixture was left with stirring for 2 hours. The emulsion is then cooled to room temperature over the course of 15 minutes. It was filtered using a Perlon filter (100 μm), to give the aqueous emulsions in question.

TABLE 4
Emulsions of ethylene copolymers (B)

| | | Conc. H₃PO₄ | Amount | | | Solids |
|---|---|---|---|---|---|---|
| | Amount | [g] | of H₂O | Molar ratio | pH of | content |
| | of (B) | in water, | [g], | of amino | emul- | [% by |
| No. | [g] | Feed 1 | Feed 2 | groups:acid | sion | weight] |
| (B.2) | 225 | 26.4 g H₃PO₄ | 873.6 | 1:1 | 5.2 | 20 |
| | | in 873 ml H₂O | | | | |
| (B.5) | 225 | 22.8 g H₃PO₄ | 877.2 | 1:1 | 4.7 | 20 |
| | | in 873 ml H₂O | | | | |
| (B.6) | 225 | 22.0 g H₃PO₄ | 878.04 | 1:1 | 4.6 | 20 |
| | | in 878 g H₂O | | | | |

### 3. Inventive Treatment of Cellulose Fibers

A standard beater with a capacity of 2.5 l was charged with 60 g of dry, unbleached long-fiber Kraft pulp as pulp (A.1) and 2 liters of water with the following properties: Mixed into this pulp slurry over a period of 10 minutes (30 000 revolutions of the propeller) were 3 g of an emulsion of ethylene copolymer (B.2) from Table 3, Example 2, at room temperature. The pulp slurry obtainable in this way was subsequently filtered with suction on a suction filter, and standard sheets were produced on a Rapid-Köthen sheet former.

Modified cellulose fibers of the invention were obtained. They gave an excellent debonding effect of 78%. This debonding effect was measured as the percentage reduction in sheet strength in relation to a pulp without the inventive treatment.

### 4. Production of Inventive Composite Material VWS.1

In a twin-screw extruder, polyethylene (C.1), an HDPE having an MFR of 31 g/10 min, measured at 190° C. under a load of 2.16 kg in accordance with ISO 1133, and inventive modified cellulose fibers according to Example 3, in a weight ratio of 7:3, and also 1% by weight of ethylene-methacrylic acid copolymer (D.1), based on the sum of polyethylene (C.1) and inventive modified cellulose fibers according to Example 3, were extruded with one another at 200° C. This gave an inventive composite material VWS.1, which in comparison to the respective unreinforced HDPE had three times the stiffness (elasticity modulus) and twice the tensile strength.

1-17. (canceled)

18. A method for producing composite materials which comprises in one step preparing modified cellulose fibers by treating
(A) cellulose fibers with an
aqueous emulsion of
(B) at least one ethylene copolymer having a molecular weight Mₙ of up to 20 000 g/mol maximum and
comprising as comonomers in incorporated form
(a) 50% to 95% by weight of ethylene,
(b) 5% to 50% by weight of at least one comonomer having at least one alkylated or cycloalkylated amino group which is connected via a spacer to a polymerizable group,
(c) 0% to 30% by weight of other comonomers,
followed by drying
and in a further step by mixing modified cellulose fibers with
(C) at least one thermoplastic
(D) and optionally one or more adjuvants.

19. The method according to claim 18, wherein comonomer (b) is a compound of the general formula I or I a, 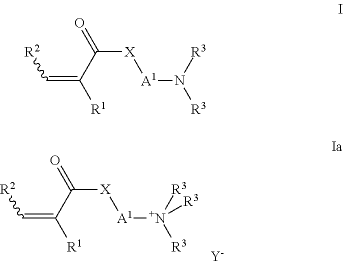
in which the variables are defined as follows:
R¹ is selected from hydrogen, unbranched and branched C₁-C₁₀-alkyl,
R² is selected from hydrogen, unbranched and branched C₁-C₁₀-alkyl,
R³ is identical or different at each occurrence and is selected from hydrogen and unbranched and branched C₁-C₁₀-alkyl and C₃-C₁₂-cycloalkyl, it being possible for two radicals R³ to be connected to one another to form a 3- to 10-membered ring,
X is selected from oxygen, sulfur, and N—R⁴,
R⁴ is selected from hydrogen and unbranched and branched C₁-C₁₀-alkyl,
A¹ is a divalent group selected from C₁-C₁₀-alkylene, C₄-C₁₀-cycloalkylene, and phenylene, and
Y⁻ is an anion of an inorganic or organic acid.

20. The method according to claim 18, wherein the variables are selected as follows:
R¹ hydrogen or methyl,
R² hydrogen,
R³ identical at each occurrence and selected from methyl and ethyl.

21. The method according to claim 18, wherein cellulose fibers (A) are wood fibers.

22. The method according to claim 18, wherein the cellulose fibers (A) are long-fiber pulp.

23. The method according to claim 18, wherein thermoplastic (C) is polyethylene, polypropylene, polyvinyl chloride, polystyrene, or polyester.

24. Cellulose fibers treated with at least one aqueous emulsion of
(B) at least one ethylene copolymer having a molecular weight Mₙ of up to 20 000 g/mol maximum and comprising as comonomers in incorporated form
(a) 50% to 95% by weight of ethylene,
(b) 5% to 50% by weight of at least one comonomer having at least one alkylated or cycloalkylated amino group which is connected via a spacer to a polymerizable group, and
(c) 0% to 30% by weight of other comonomers.

25. The cellulose fibers according to claim 24, which are free from thermoplastic (C).

26. The cellulose fibers according to claim 24, wherein the weight ratio of cellulose fibers (A) to ethylene copolymer (B) is in the range from 1000:1 to 20:1.

27. The cellulose fibers according to claim 24, wherein cellulose fibers are long-fiber pulp.

28. The cellulose fibers according to claim 24, wherein the cellulose fibers have a residual moisture content in the range from 0.1% to 20% by weight.

29. A process for producing a composite material which comprises utilizing the modified cellulose fibers according to claim 24.

30. The process according to claim 29, wherein the composite material comprises at least one thermoplastic (C).

31. The process according to claim 29, wherein the composite material comprises glass fibers.

32. A composite material comprising the cellulose fibers according to claim 24.

33. Building exterior parts, building interior parts, profile parts, furniture or hollow articles which comprises the composite material according to claim 32.

34. A process for producing building exterior parts, building interior arts, profile parts, palettes, interior trim and underbody trim in the automotive sector, furniture or hollow articles which comprises utilizing the composite as claimed in claim 32.
